(19) United States
(12) Patent Application Publication
(10) Pub. No.: US 2017/0349148 A1
(43) Pub. Date: Dec. 7, 2017

(54) METHOD AND APPARATUS FOR DETECTING ROAD CONDITION DATA AND WEATHER CONDITION DATA USING VEHICULAR CROWD-SENSING

(71) Applicant: GM GLOBAL TECHNOLOGY OPERATIONS LLC, Detroit, MI (US)

(72) Inventors: DAVID E. BOJANOWSKI, CLARKSTON, MI (US); FAN BAI, ANN ARBOR, MI (US); JINZHU CHEN, TROY, MI (US); DONALD K. GRIMM, UTICA, MI (US)

(73) Assignee: GM GLOBAL TECHNOLOGY OPERATIONS LLC, Detroit, MI (US)

(21) Appl. No.: 15/604,298

(22) Filed: May 24, 2017

Related U.S. Application Data
(60) Provisional application No. 62/345,613, filed on Jun. 3, 2016.

(51) Int. Cl. B60S 1/08; B60Q 1/20; G01C 21/28; G07C 5/00; G01W 1/02

(52) U.S. Cl. CPC B60S 1/0859; G07C 5/008; G01W 1/02; G01C 21/28; B60Q 1/20; B60S 1/0866; B60S 1/0862; B60S 1/0874

(57) ABSTRACT

A method for acquiring road data onboard a vehicle, the road data associated with a segment of road is provided. The method obtains, via vehicle onboard sensors, sensor data associated with current weather conditions, current road conditions, and a physical road state; determines whether the current weather conditions indicate existence of severe weather, whether the current road conditions indicate potential slip, and whether the physical road state indicates one or more road anomalies; generates a road data result, based on existence of severe weather, potential slip, and one or more road anomalies; and transmits the road data result, via a vehicle onboard telematics unit.

### CROSS-REFERENCE TO RELATED APPLICATION(S)

This application claims the benefit of U.S. provisional patent application Ser. No. 62/345,613, filed Jun. 3, 2016.

### TECHNICAL FIELD

Embodiments of the subject matter described herein relate generally to data acquisition associated with road conditions and weather conditions in a particular area. More particularly, embodiments of the subject matter relate to vehicle onboard data acquisition, interpretation, collection, and use to generate advisory data.

### BACKGROUND

Conditions along a particular driving route can create an unexpected driving environment in a particular geographic area. Such conditions may include road surface conditions (e.g., slip), road anomalies (e.g., potholes, ramps, bumps), and weather conditions (e.g., fog, rain). In certain situations, a driver may elect to avoid such conditions, by taking a different route or altering the timing of a trip. However, a driver may not become aware of existing driving conditions until such conditions are encountered, when it may be too late to make changes to the selected driving route.

Accordingly, it is desirable to for a driver to be aware of driving conditions for a particular area, prior to travelling in that area. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present disclosure provide a method for acquiring road data onboard a vehicle, the road data associated with a segment of road. The method obtains, via vehicle onboard sensors, sensor data associated with current weather conditions, current road conditions, and a physical road state; determines whether the current weather conditions indicate existence of severe weather, whether the current road conditions indicate potential slip, and whether the physical road state indicates one or more road anomalies; generates a road data result, based on existence of severe weather, potential slip, and one or more road anomalies; and transmits the road data result, via a vehicle onboard telematics unit.

Some embodiments provide a system for acquiring road data onboard a vehicle. The system includes a system memory element; a plurality of vehicle onboard sensors, configured to obtain sensor data associated with current weather conditions, current road conditions, and a physical road state; a vehicle onboard telematics device, configured to transmit data to a remote server; at least one processor, communicatively coupled to the system memory element, the plurality of vehicle onboard sensors, and the vehicle onboard telematics unit, the at least one processor configured to: identify the current weather conditions, the current road conditions, and the physical road state, based on the sensor data; determine whether the current weather conditions indicate existence of severe weather, whether the current road conditions indicate potential slip, and whether the physical road state indicates one or more road anomalies; generate a road data result, based on existence of severe weather, potential slip, and one or more road anomalies; and initiate transmission of the road data result, via the vehicle onboard telematics device.

Some embodiments provide a method for analyzing a driving route at a centralized computer system. The method requests, via a communication device of the centralized computer system, driving condition data from a plurality of vehicles in operation on the driving route, based on a location of each of the plurality of vehicles; receives the driving condition data, via the communication device; filters, by the centralized computer system, the driving condition data to obtain relevant driving condition data; stores the relevant driving condition data in a system memory element at the centralized computer system; generates, by the centralized computer system, notifications associated with severe weather, road anomalies, and slippery roads, based on the relevant driving condition data; and transmits, via the communication device, the notifications to a second plurality of vehicles approaching the driving route.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a driving condition detection system, in accordance with the disclosed embodiments;

FIG. 2 is a functional block diagram of a vehicle onboard computer system, in accordance with the disclosed embodiments;

FIG. 3 is a functional block diagram of a centralized computer system of a driving condition detection system, in accordance with the disclosed embodiments;

FIG. 4 is a flow chart that illustrates an embodiment of a process for acquiring road data onboard a vehicle;

FIG. 5 is a flow chart that illustrates an embodiment of a process for identifying severe weather conditions associated with a driving route;

FIG. 6 is a flow chart that illustrates an embodiment of a process for identifying road anomalies associated with a driving route;

FIG. 7 is a flow chart that illustrates an embodiment of a process for identifying a slip condition associated with a driving route;

FIG. 8 is a flow chart that illustrates an embodiment of a process for analyzing a driving route at a centralized computer system in communication with a plurality of vehicles traveling the driving route; and

FIG. 9 is a flow chart that illustrates an embodiment of a process for selective sensing of driving condition data acquired and calculated by a plurality of vehicles operating on a driving route.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to a vehicle-cloud system architecture that aggregates, processes and data-mines data from multiple vehicles to identify a variety of road anomaly events, by monitoring temporal and statistical deviations from regular traffic patterns. Each vehicle computes driving condition data for a segment of a road while driving on the road, and the driving condition data is transmitted to a centralized computer system. This centralized computer system uses the driving condition data to generate alerts and transmits the alerts to other vehicles traveling the same segment of the road.

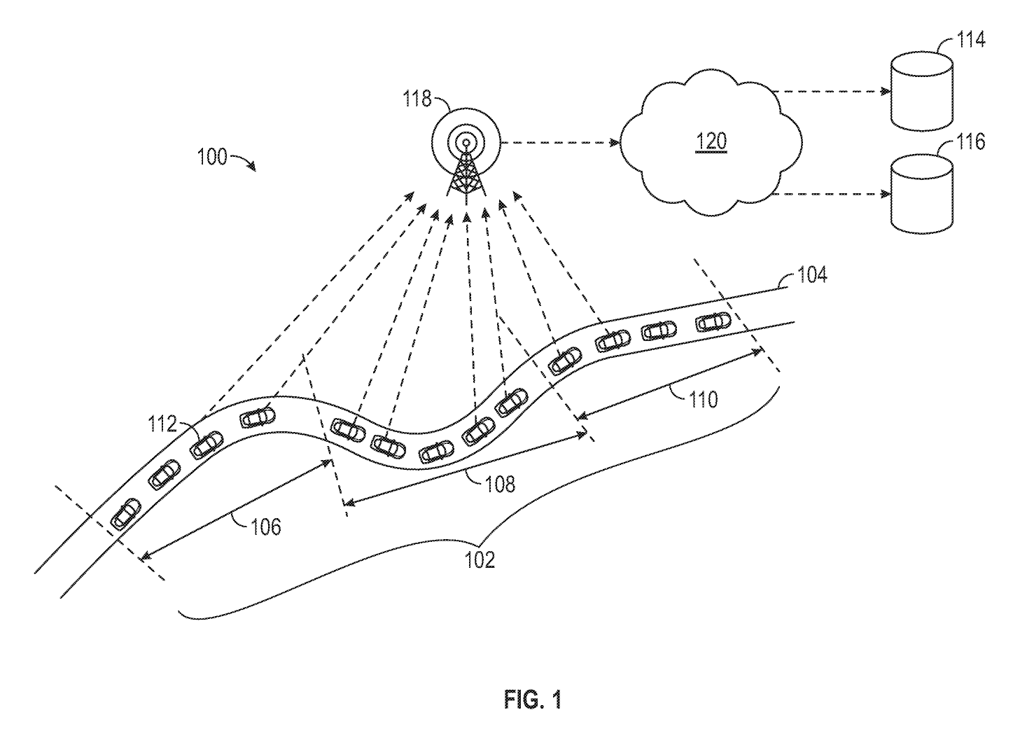

Turning now to the figures, FIG. 1 is a diagram of a driving condition detection system 100, in accordance with the disclosed embodiments. The driving condition detection system 100 includes a plurality of vehicles 102 traveling on route 104. Each of the plurality of vehicles 102 may be any one of a number of different types of types of automobiles (sedans, wagons, trucks, motorcycles, sport-utility vehicles, vans, etc.), aviation vehicles (such as airplanes, helicopters, etc.), watercraft (boats, ships, jet skis, etc.), trains, all-terrain vehicles (snowmobiles, four-wheelers, etc.), military vehicles (Humvees, tanks, trucks, etc.), rescue vehicles (fire engines, ladder trucks, police cars, emergency medical services trucks and ambulances, etc.), spacecraft, hovercraft, and the like.

As shown, route 104 is divided into segments 106, 108, 110. Each of the vehicles 102 obtains vehicle sensor data while driving the route 104, and the vehicle sensor data is associated with behavior of the vehicle when driving in a particular location (e.g., segment of the road). Each of the vehicles 102 is equipped with a vehicle onboard computer system (not shown), which uses the obtained sensor data to compute appropriate driving condition data associated with a particular location. For example, as vehicle 112 travels through segment 106, vehicle 112 collects vehicle sensor data, including, without limitation: acceleration data, vibration data, lateral acceleration data, vertical acceleration data, rain sensor data, windshield wiper sensor data, fog light sensor data, inside/outside temperature data, and other vehicle sensor data. Vehicle 112 uses the obtained sensor data to perform calculations to determine whether particular driving conditions exist in segment 106. Here, vehicle 112 performs calculations to determine whether severe weather conditions, road anomalies, and/or slippery road conditions exist in segment 106.

Once the driving condition data, specific to each location (e.g., segment of a particular road 104) is calculated and determined, each of the vehicles 102 transmits the driving condition data to a remote server 114 and/or a centralized computer system 116 for storage and future use. Generally, each of the vehicles 102 is equipped with a vehicle onboard telematics device capable of transmitting data wirelessly to a cellular base station 118, which further transmits the data (via a wireless data communication network 120) to the remote server 114 and/or the centralized computer system 116.

The data communication network 120 may be any digital or other communications network capable of transmitting messages or data between devices, systems, or components. In certain embodiments, the data communication network 120 includes a packet switched network that facilitates packet-based data communication, addressing, and data routing. The packet switched network could be, for example, a wide area network, the Internet, or the like. In various embodiments, the data communication network 120 includes any number of public or private data connections, links or network connections supporting any number of communications protocols. The data communication network 120 may include the Internet, for example, or any other network based upon TCP/IP or other conventional protocols. In various embodiments, the data communication network 120 could also incorporate a wireless and/or wired telephone network, such as a cellular communications network for communicating with mobile phones, personal digital assistants, and/or the like. The data communication network 120 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

In embodiments using a centralized computer system 116, the centralized computer system 116 uses the transmitted driving condition data to generate notifications or alerts associated with the driving condition data, and transmits these notifications to one or more of the vehicles 102 driving along a particular segment 106, 108, 110 of the route 104. For example, vehicle 112 may transmit driving condition data, such as an indication of severe weather, associated with segment 106 to the centralized computer system 116. The centralized computer system 116 may then generate severe weather notifications and transmit these severe weather notifications to a subset of the vehicles 102 that are traveling on segment 106.

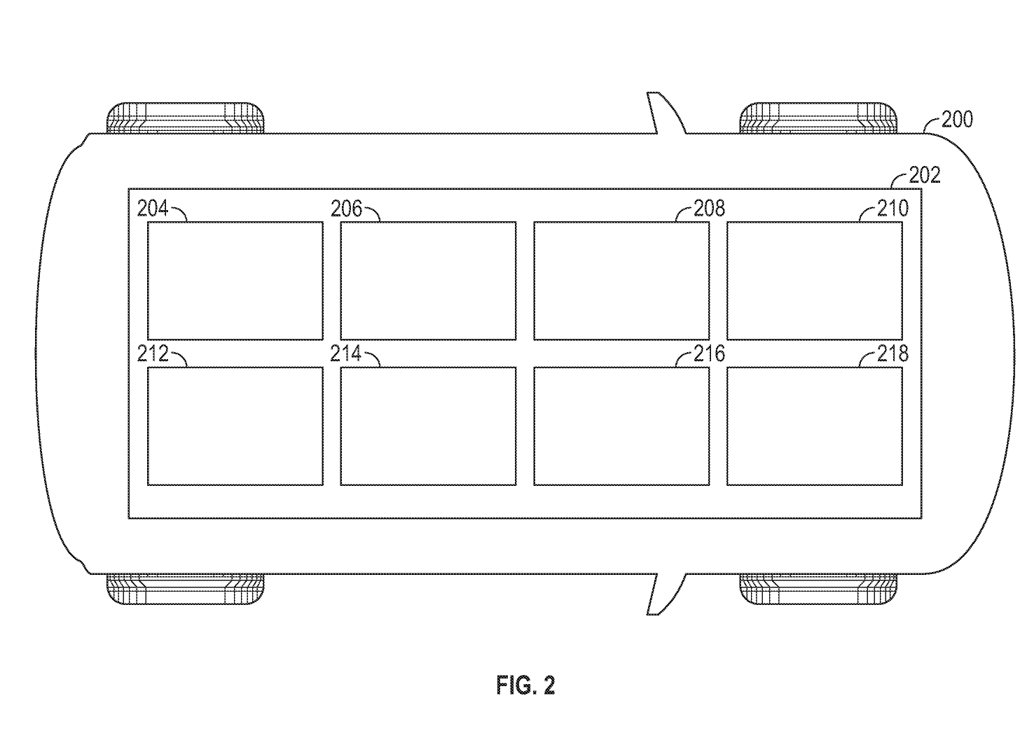

FIG. 2 is a functional block diagram of a vehicle 200 that includes a vehicle onboard computer system 202, in accordance with the disclosed embodiments. The vehicle onboard computer system 202 may be implemented using any number (including only one) of electronic control modules onboard the vehicle 200; an integrated computer system implemented in the interior of the vehicle 200 and configured for use during operation of the vehicle 200; and/or a standalone, personal computing device (e.g., a tablet computer, laptop computer, smartphone) configured to communicate with vehicle onboard sensors 208 using a wired or wireless connection. The onboard computer system 202 includes various informational and/or entertainment (i.e., “infotainment”) system components that are not illustrated in FIG. 2 for sake of clarity, such as one or more ports (e.g., USB ports), one or more Bluetooth interface(s), input/output devices, one or more display(s), one or more audio system(s), one or more radio systems, and a navigation system. In one embodiment, the input/output devices, display(s), and audio system(s) collectively provide a human machine interface (HMI) inside the vehicle. It should be noted that the vehicle onboard computer system 202 can be implemented onboard one or more of the vehicles 102 depicted in FIG. 1. In this regard, the vehicle onboard computer system 202 shows certain elements and components of each of the vehicles 102 in more detail.

The vehicle onboard computer system 202 generally includes, without limitation: at least one processor 204; a system memory element 206; a plurality of vehicle onboard sensors 208; a telematics device 210; a weather condition calculation module 212; a road anomaly calculation module 214; a slip condition calculation module 216; and a display device 218. These elements and features of the vehicle onboard computer system 200 may be operatively associated with one another, coupled to one another, or otherwise configured to cooperate with one another as needed to support the desired functionality, as described herein. For ease of illustration and clarity, the various physical, electrical, and logical couplings and interconnections for these elements and features are not depicted in FIG. 2. Moreover, it should be appreciated that embodiments of the vehicle onboard computer system 200 will include other elements, modules, and features that cooperate to support the desired functionality. For simplicity, FIG. 2 only depicts certain elements that relate to the driving condition and road condition calculation techniques described in more detail below.

The at least one processor 204 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 204 may be realized as one or more microprocessors, controllers, microcontrollers, or state machines. Moreover, the at least one processor 204 may be implemented as a combination of computing devices, e.g., a combination of digital signal processors and microprocessors, a plurality of microprocessors, one or more microprocessors in conjunction with a digital signal processor core, or any other such configuration.

The system memory element 206 may be realized using any number of devices, components, or modules, as appropriate to the embodiment. Moreover, the vehicle onboard computer system 202 could include system memory 206 integrated therein and/or system memory 106 operatively coupled thereto, as appropriate to the particular embodiment. In practice, the system memory element 206 could be realized as RAM memory, flash memory, EPROM memory, EEPROM memory, registers, a hard disk, a removable disk, or any other form of storage medium known in the art. In certain embodiments, the system memory 106 includes a hard disk, which may also be used to support functions of the onboard computer system 202. The system memory element 206 can be coupled to the processor architecture 104 such that the at least one processor 204 can read information from, and write information to, the system memory element 206. In the alternative, the system memory element 206 may be integral to the at least one processor 204. As an example, the at least one processor 204 and the system memory element 206 may reside in a suitably designed application-specific integrated circuit (ASIC).

The plurality of vehicle onboard sensors 208 may include any number of onboard sensors, instruments, or devices, as is well understood. Vehicle sensor data may include, without limitation: acceleration data, vibration data, lateral acceleration data, vertical acceleration data, rain sensor data, windshield wiper sensor data, fog light sensor data, inside/outside temperature data, and other vehicle sensor data.

The telematics device 210 is suitably configured to communicate data between the onboard computer system 202 and one or more remote servers. In certain embodiments, the telematics device 210 is implemented as an onboard vehicle communication or telematics system, such as an OnStar® module commercially marketed and sold by the OnStar® corporation, which is a subsidiary of the assignee of the instant Application, the General Motors Company, currently headquartered in Detroit, Mich. In embodiments wherein the telematics device 210 is an OnStar® module, an internal transceiver may be capable of providing bi-directional mobile phone voice and data communication, implemented as Code Division Multiple Access (CDMA). In some embodiments, other 3G technologies may be used to implement the telematics device 210, including without limitation: Universal Mobile Telecommunications System (UMTS) wideband CDMA (W-CDMA), Enhanced Data Rates for GSM Evolution (EDGE), Evolved EDGE, High Speed Packet Access (HSPA), CDMA2000, and the like. In some embodiments, 4G technologies may be used to implement the network interface module 112, alone or in combination with 3G technologies, including without limitation: Evolved High Speed Packet Access (HSPA+), Long Term Evolution (LTE) and/or Long Term Evolution-Advanced (LTE-A).

As described in more detail below, data received by the telematics device 210 may include, without limitation, requests for driving condition/road condition data, and other data compatible with the onboard computer system 202. Data provided by the telematics device 210 may include, without limitation, vehicle sensor data, calculated driving condition data (e.g., severe weather data, road anomaly data, road slip data), and the like.

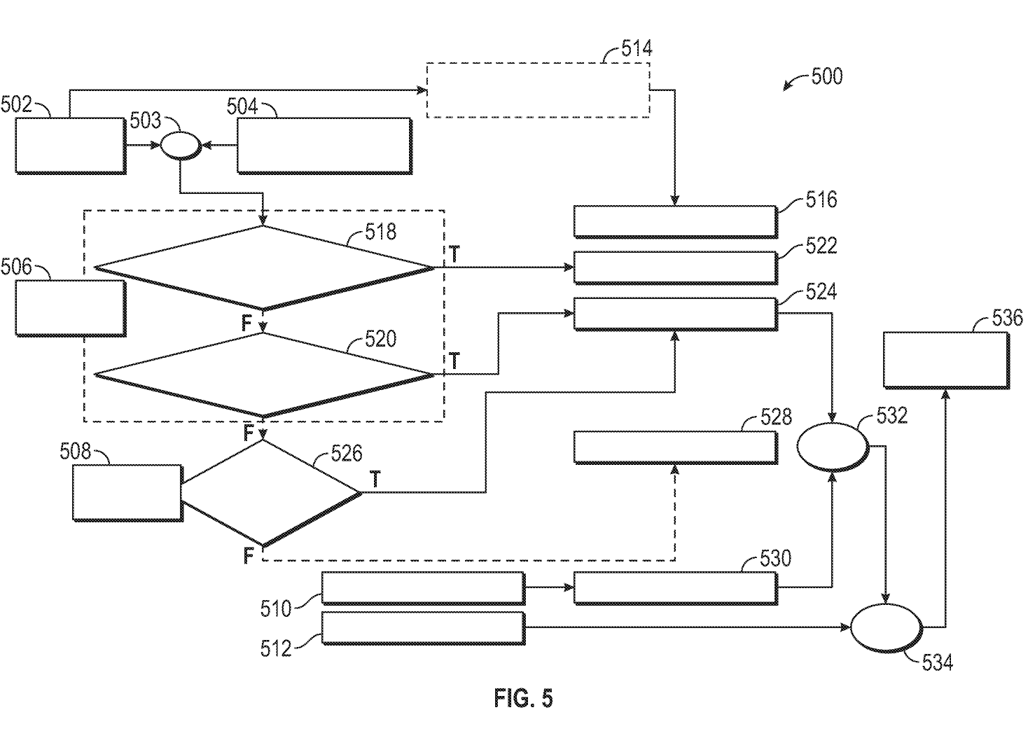

The weather condition calculation module 212 is suitably configured to perform calculations associated with identifying severe weather conditions for a geographic location of the vehicle 200. One exemplary embodiment of these calculations is shown in the flowchart of FIG. 5. The weather condition calculation module 212 uses rain sensors and/or windshield wiper sensors (e.g., vehicle onboard sensors 208) to determine whether a rain condition exists (i.e., whether it is raining outside the vehicle). The weather condition calculation module 212 then identifies an outside air temperature, using temperature sensors, and communicates with a 3^{rd} party weather API, to determine whether the rain condition indicates rain or snow. The weather condition calculation module 212 also detects fog light sensor data and fog light level data, to determine whether a fog condition exists outside the vehicle.

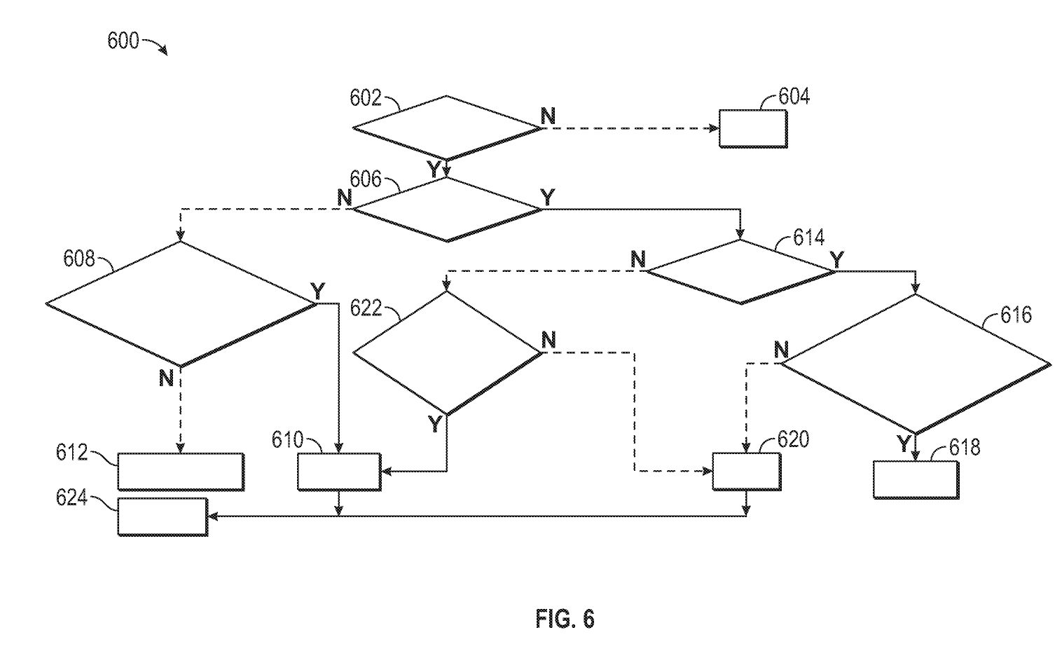

The road anomaly calculation module 214 is configured to perform calculations associated with identifying road anomalies for a geographic location of the vehicle 200. One exemplary embodiment of these calculations is shown in the flowchart of FIG. 6. The logic of pothole detection is based on a variety of signal patterns when vehicle is passing through different road anomaly/features, such as pothole, speed bump and surface cracks. First, the road anomaly calculation module 214 identifies large vibrations caused by hitting the anomaly or road features. The road anomaly calculation module 214 measures vibrations using rough road magnitude (rrm), wherein only significant vibrations are considered. Then, due to the limited size of most potholes, the potholes usually hit one side of the vehicle, generating asymmetric lateral accelerations. The road anomaly calculation module 214 detects such asymmetric lateral accelerations. In some cases, cars will hit the speed bump asymmetrically. Therefore, the road anomaly calculation module 214 further evaluates the vertical acceleration pattern sensed by smartphone. A normal speed bump pattern will show that the acceleration increases upwards first, compared to increase downwards first for potholes. Finally, the road anomaly calculation module 214 detects some large road crack segment (with N(t), b_z, x_m/f) as potholes, which may include the pattern for speed bumps as well.

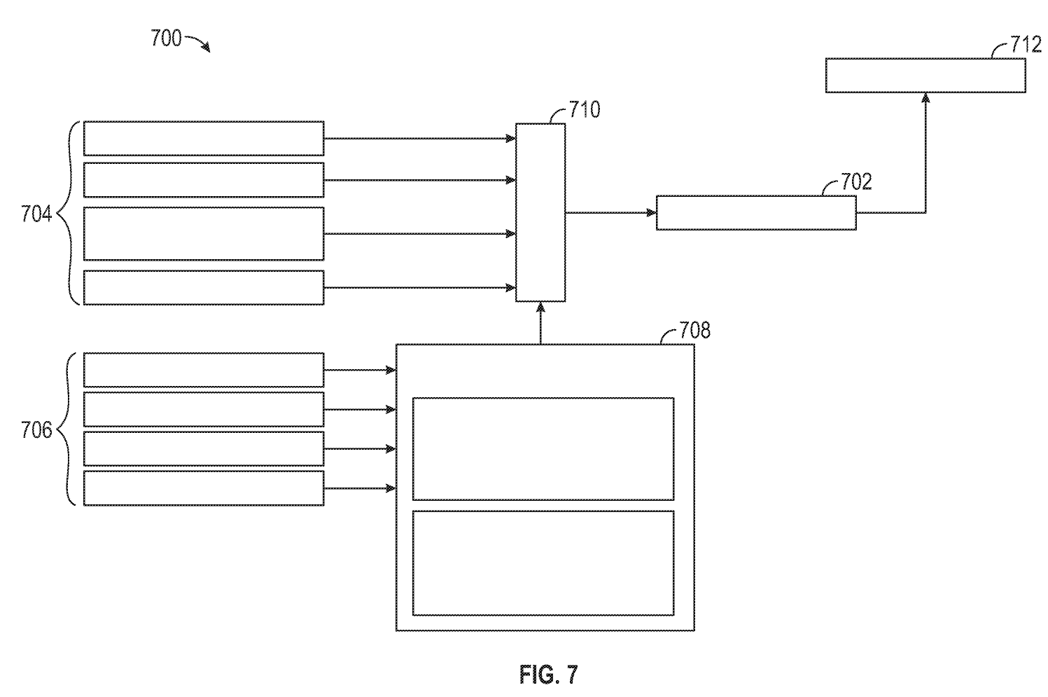

The slip condition calculation module 216 is configured to perform calculations associated with identifying road slip conditions (or lack thereof) for a geographic location of the vehicle 200. One exemplary embodiment of these calculations is shown in the flowchart of FIG. 7. First, the slip condition calculation module 216 adopts the existing signals transmitted via a CAN bus onboard the vehicle, which reflect whether or not a slip is detected. Then, the slip condition calculation module 216 explores the early slip detection by using other vehicle dynamics signals. In this exemplary embodiment, the slip condition calculation module 216 calculates the slip_angle and self aligning torque from four CAN bus signals. Initially, the self-aligning torque increases as slip angle. If the road is slippery, the self aligning torque will decrease while the slip angle increases. Thus, the slip condition calculation module 216 detects the early slip condition when self-aligning torque is decreasing while increasing the slip angle.

In practice, the weather condition calculation module 212, the road anomaly calculation module 214, and/or the slip condition calculation module 216 may be implemented with (or cooperate with) the at least one processor 204 to perform at least some of the functions and operations described in more detail herein. In this regard, the weather condition calculation module 212, the road anomaly calculation module 214, and/or the slip condition calculation module 216 may be realized as suitably written processing logic, application program code, or the like.

The display device 218 is configured to present various icons, text, and/or graphical elements associated with notifications or alerts associated with driving conditions for a particular geographic area. In an exemplary embodiment, the display device 218 is communicatively coupled to a user interface (not shown) and the at least one processor 204. In this scenario, the at least one processor 204, the user interface, and the display device 218 are cooperatively configured to display, render, or otherwise convey one or more graphical representations or images associated with driving conditions for a particular geographic area on the display device 218, as described in greater detail below. In an exemplary embodiment, the display device 218 is realized as an electronic display configured to graphically display driving condition data, as described herein. In some embodiments, the vehicle onboard computer system 202 is an integrated computer system onboard a vehicle 200, and the display device 218 is located within the interior of the vehicle 200, and is thus implemented as an integrated vehicle display. In other embodiments, the display device 218 is implemented as a display screen of a standalone, personal computing device (e.g., laptop computer, tablet computer). It will be appreciated that although the display device 218 may be implemented using a single display, certain embodiments may use additional displays (i.e., a plurality of displays) to accomplish the functionality of the display device 218 described herein.

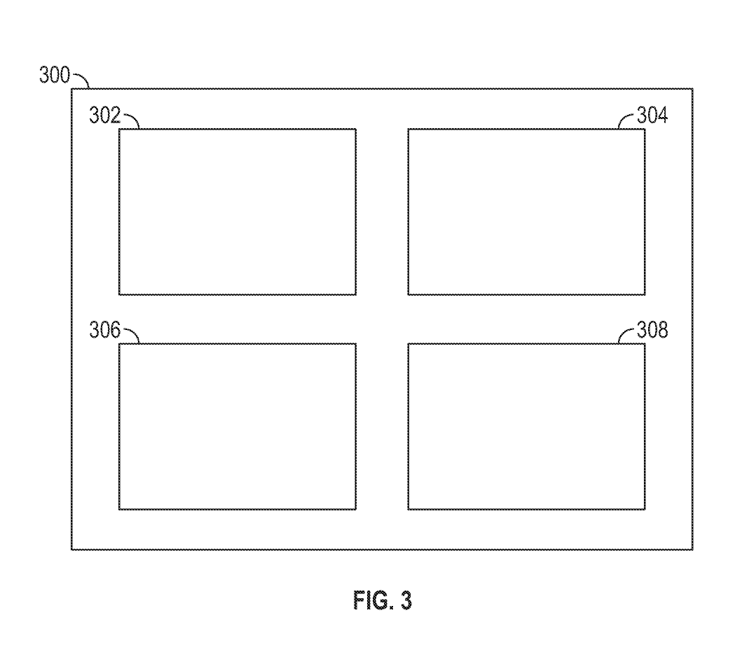

FIG. 3 is a functional block diagram of a centralized computer system 300 of a driving condition detection system, in accordance with the disclosed embodiments. It should be noted that the centralized computer system 300 can be implemented using the centralized computer system 116 depicted in FIG. 1. In this regard, the centralized computer system 300 shows certain elements and components of the centralized computer system 116 in more detail. The centralized computer system 300 functions to (i) receive driving condition data from a plurality of vehicles driving in a particular geographic location and/or driving on a particular segment of a particular road, and (i) use the received driving condition data to generate alerts and transmit the alerts to other vehicles traveling the same segment of the road.

The centralized computer system 300 generally includes, without limitation: at least one processor 302; system memory 304; a notification generation module 306; and an input/output (I/O) communication device 308. Similar elements of at least one processor 302 and system memory 304 are described in detail with regard to FIG. 2, and will not be redundantly described here. The notification generation module 306 is configured to generate notifications and alerts associated with driving conditions for a particular location (e.g., severe weather, road anomalies, and road slip conditions).

The communication device 308 is suitably configured to communicate data between the centralized computer system 300 and one or more vehicle onboard computer systems implemented onboard a plurality of vehicles. The communication device 308 is implemented using any hardware compatible with a communication protocol used by a vehicle onboard computer system (reference 202 of FIG. 2). The communication device 308 may transmit and receive communications over a wireless local area network (WLAN), the Internet, a satellite uplink/downlink, a cellular network, a broadband network, a wide area network, or the like. As described in more detail below, data received by the communication device 308 may include, without limitation, driving condition data transmitted by a plurality of vehicles, and other data compatible with the centralized computer system 300. Data provided by the communication device 308 may include, without limitation, notifications and alerts to one or more vehicles, alerting drivers to severe weather, speed bumps, potholes, cracks, joints, and slick roads, and the like.

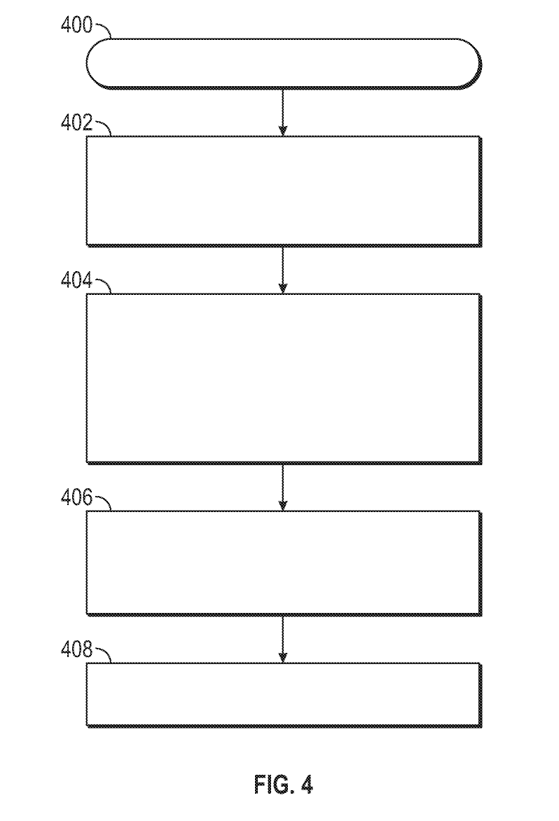

FIG. 4 is a flow chart that illustrates an embodiment of a process 400 for acquiring road data onboard a vehicle. First, the process 400 obtains, via vehicle onboard sensors, sensor data associated with current weather conditions, current road conditions, and a physical road state (step 402).

Next, the process 400 determines whether the current weather conditions indicate existence of severe weather, whether the current road conditions indicate potential slip, and whether the physical road state indicates one or more road anomalies (step 404). One suitable methodology for obtaining sensor data associated with current weather conditions (step 402) and determining whether the current weather conditions indicate existence of severe weather (step 404) is described below with reference to FIG. 5. One suitable methodology for obtaining sensor data associated with current road conditions (step 402) and determining whether the current road conditions indicate potential slip (step 404) is described below with reference to FIG. 6. One suitable methodology for obtaining sensor data associated with a physical road state (step 402) and determining whether the physical road state indicates one or more road anomalies (step 404) is described below with reference to FIG. 7.

Severe weather may include rain, fog, and/or snow, and in some embodiments, may be indicated by a level of a weather condition (e.g., heavy rain, heavy snow) or a combination of a weather condition with fog and/or reduced visibility due to darkness (e.g., a nighttime condition). Potential slip may include any condition in which a vehicle may experience a reduction in road friction, potentially resulting in a failure of the vehicle tires to engage and grip the roadway causing the vehicle to inadvertently slide. Road anomalies may include road bumps, road ramps, potholes, or the like. The process 400 then generates a road data result, based on the existence of severe weather, potential slip, and one or more road anomalies (step 406).

Next, the process 400 transmits the road data result, via a vehicle onboard telematics device (step 408). The road data result may be transmitted to a centralized computer system for future use and potential transmission to other vehicles travelling in the same geographic location (e.g., the same road, the same segment of road) for informational purposes.

FIG. 5 is a flow chart that illustrates an embodiment of a process 500 for identifying severe weather conditions associated with a driving route, in accordance with the disclosed embodiments. The process 500 may be executed by a computing device onboard a particular vehicle (e.g., a vehicle onboard computer system, an electronic control unit (ECU), a standalone computing device), and obtains information and makes determinations for the particular vehicle. It should be appreciated that the process 500 described in FIG. 5 represents one embodiment of steps 402 and 404 described above in the discussion of FIG. 4, including additional detail.

First, the process 500 determines whether the windshield wipers are “on” or activated (step 502) or whether a rain-sensor onboard the vehicle is active (step 504), wherein reference 503 indicates the logical OR operation. Here, the process 500 uses rain sensors and/or windshield wiper sensors to determine whether a rain condition exists (i.e., whether it is raining outside the vehicle). In certain embodiments, when the windshield wipers are active (step 502), then the process 500 uses a wiper level estimator (step 514) to determine a level of precipitation (step 516). In other words, when the windshield wipers are turned on and operating, the process 500 identifies the setting of the windshield wipers. The setting may include fast, normal, slow, operating at an interval of time, or the like. When the setting is fast, the process 500 determines that the level of precipitation is high, and when the setting is slower or at an interval, the process 500 determines that the level of precipitation is low. The level of precipitation may be stored for transmission to a centralized computer system (see FIGS. 1 and 3) for use in generating and transmitting notifications and alerts to other vehicles.

When the windshield wiper sensor indicates that the windshield wipers are active (step 502) or the rain sensor is active (step 504), then the process 500 continues and identifies an outside air temperature, using temperature sensors (step 506). When the outside air temperature is greater than a threshold (the “True” branch of 518), then the process 500 determines that a rain condition exists outside the vehicle (step 522). The threshold is a temperature value above which precipitation does not freeze, indicating that any precipitation outside the vehicle is rain and is not snow. The threshold value is determined at design time and is programmed into the vehicle onboard computer system executing the process 500.

However, when the outside air temperature is less than a threshold (the “False” branch of 518), then the process 500 determines whether the outside air temperature is less than a second threshold (decision 520). When the outside air temperature is less than the second threshold (the “True” branch of 520), then the process 500 determines that a snow condition exists outside the vehicle (step 524). The second threshold is a temperature value below which precipitation freezes, indicating that any precipitation outside the vehicle is snow and is not rain. Like the threshold value described previously with regard to decision 518, the second threshold value is determined at design time and is programmed into the vehicle onboard computer system executing the process 500.

However, when the outside air temperature is not less than the second threshold (the “False” branch of 520), then the process 500 determines whether a third party cloud application indicates a snow condition (decision 526). Here, the process 500 communicates with a third party weather application programming interface (API) (step 508), to determine whether the rain condition indicates rain or snow (decision 526).

When the third party weather API indicates a snow condition (the “True” branch of 526), then the process 500 determines that a snow condition exists outside the vehicle (step 524). When the third party weather API does not indicate a snow condition (the “False” branch of 526), then the process 500 determines that a rain condition exists outside the vehicle (step 528).

The process 500 also communicates with a fog light indicator (step 510) to determine whether a fog condition exists outside the vehicle (step 530) and to determine whether a light level of the fog light indicator indicates that a night condition exists outside the vehicle (step 512). In other words, the process 500 determines whether it is foggy outside the vehicle by determining whether the fog lights of the vehicle are turned on, and the process 500 whether it is nighttime outside the vehicle by identifying a current fog light level of the fog lights of the vehicle. When the fog light level is high, then the process 500 determines that it is dark outside the vehicle, and it is thus nighttime outside the vehicle.

The process 500 thus identifies a rain condition (steps 522, 528), a snow condition (step 524), and/or a fog condition (step 530) outside the vehicle. In some embodiments, identification of the rain condition (steps 522, 528) may cause the process 500 to automatically generate a notification or advisory (step 536) associated with the weather outside the vehicle.

The process 500 uses a logical OR (step 532) to compare the snow condition (step 524) to the fog condition (step 530), and to determine whether the snow condition (step 524) or the fog condition (step 530) is true. When there exists a snow condition or a fog condition, or both a snow condition and a fog condition, outside the vehicle, then the snow condition or the fog condition is compared to the fog light level condition (step 512). When the process 500 identifies a snow condition (step 524) or a fog condition (step 530), then the process 500 uses a logical AND (step 534) to determine that the fog light level indicates a nighttime condition (step 512) outside the vehicle also. Thus, when there is snow or fog (or both snow and fog) and it is nighttime outside the vehicle, then a notification or advisory is generated by the process 500 (step 536). The precipitation level (step 516) may be included in the notification or advisory that is generated.

FIG. 6 is a flow chart that illustrates an embodiment of a process 600 for identifying road anomalies associated with a driving route.

The process 600 uses vehicle onboard sensors to detect vibrations of the vehicle, which are generally produced when the surface that the vehicle is driving over is not completely smooth. First, the process 600 determines whether a detected vibration is a large vibration (decision 602). In this case, the process 600 determines whether a detected vibration, quantified using well-known and commonly used vibration detection technology, is a larger vibration than a threshold vibration value.

When the detected vibration is not larger than a threshold vibration value (the “No” branch of 602, then the process 600 determines that the current driving surface is smooth (step 604), or in other words, the process 600 determines that the vehicle is not driving over any type of road anomaly (e.g., road bump, road crack, road joint, ramp, pothole).

However, when the detected vibration is larger than a threshold vibration value (the “Yes” branch of 602, then the process 600 determines whether the detected, large vibration is associated with an asymmetric impulse (decision 606).

When the detected, large vibration is not associated with an asymmetric impulse (the “No” branch of 606), then the process 600 determines that the current road anomaly is not a pothole, and determines whether the vertical acceleration pattern of the vehicle is consistent with road bumps (decision 608). If the vertical acceleration pattern is consistent with road bumps (the “Yes” branch of 608), then the process 600 determines that the road anomaly is a road bump or road ramp (step 610). However, if the vertical acceleration pattern is not consistent with road bumps (the “No” branch of 608), then the process 600 determines that the road anomaly is a road stripe, a road joint, or a road crack (step 612).

When the detected, large vibration is associated with an asymmetric impulse (the “Yes” branch of 606), then the process 600 determines whether the vertical acceleration pattern of the vehicle is consistent with road bumps (decision 614). If the vertical acceleration pattern is consistent with road bumps (the “Yes” branch of 614), then the process 600 determines that the road anomaly is most likely a road bump, and performs calculations to identify a potential impact of large surface cracks in the road (decision 616). When the process 600 identifies an impact of a large surface crack (the “Yes” branch of 616), then the process 600 determines that the road anomaly is a road bump or a road ramp (step 618). When the process 600 does not identify an impact of a large surface crack in the road (the “No” branch of 616), then the process 600 determines that the road anomaly is a pothole (step 620).

However, if the vertical acceleration pattern is not consistent with road bumps (the “No” branch of 614), then the process 600 determines that the road anomaly is most likely a pothole, and performs calculations to identify a potential impact of large surface cracks in the road (decision 622). When the process 600 identifies an impact of a large surface crack (the “Yes” branch of 622), then the process 600 determines that the road anomaly is a road bump or a road ramp (step 610). When the process 600 does not identify an impact of a large surface crack in the road (the “No” branch of 622), then the process 600 determines that the road anomaly is a pothole (step 620).

The process 600 may present, initiate presentation of, or recommend presentation of, an advisory or notification to alert a driver of the vehicle to the road anomalies identified by the process 600 (e.g., road stripes, road joints, road cracks, road bumps, road ramps, and potholes). Additionally, advisories and notifications may be transmitted by the process 600 to a centralized computer system such that the notifications may be provided to one or more vehicles traveling in the same geographic area that includes the road anomalies.

The logic of pothole detection is based on a variety of signal patterns when vehicle is passing through different road anomalies and/or road features (e.g., potholes, speed bump, and surface cracks). First, the process 600 looks for large vibrations caused by the vehicle making contact with the road anomaly or road features. The vibration is measured by rough road magnitude (rrm), and the process 600 only considers significant vibrations. Then, due to the limited size of most potholes, the potholes usually hit one side of the vehicle, generating asymmetric lateral accelerations. In some cases, cars will hit the speed bump asymmetrically. Therefore, we further evaluate the vertical acceleration pattern sensed by smartphone. A normal speed bump pattern will show that the acceleration increases upwards first, compared to increase downwards first for potholes. At last, we detect some large road crack segment (with N(t), b_z, x_m/f) as potholes, which may contain the pattern for speed bumps as well.

FIG. 7 is a flow chart that illustrates an embodiment of a process 700 for identifying a slip condition 702 associated with a driving route.

To identify the slip condition 702, the process 700 obtains data from a Controller Area Network (CAN) bus onboard the vehicle. First, the process 700 detects slip parameters 704 that indicate the slip condition 702, alone or in combination with other parameters. Such slip parameters 704 may include, without limitation, an active signal for a traction control system, a wheel slip status indicator, an active signal for a stability enhancement system, an active signal for an anti-lock braking system, or the like.

The process 700 also obtains slip calculation parameters 706 from communication with the CAN bus. The slip calculation parameters 706 may include, without limitation, a road wheel angle (δ), a lateral acceleration (α_{y}), a vehicle speed (νₓ), and a yaw rate (ψ). The process 700 uses the slip calculation parameters 706 to detect early slippery conditions 708, including slip angle

$$( {a}_{f} = - δ + \frac{{v}_{y} + ψ α}{{v}_{x}} )$$

and self-aligning torque

$$( {M}_{zt} = - {K}_{t} δ - {K}_{2} {α}_{v} + \frac{{K}_{3}}{{v}_{x}} ψ ) .$$

When the process 700 identifies one or more of the slip parameters 704, then the condition for the slip parameters 704 is true. When the process 700 identifies one or more potential early slippery conditions using the slip angle calculation and the self-aligning torque calculation, then the condition for the slip calculation parameters is true. The process 700 uses a logical OR to determine whether the condition indicated by at least one of the slip parameters 704 or the condition indicated by at least one of the slip calculation parameters 706 is true. When at least one of the conditions is true, then the slip condition 702 exists, and the process 700 presents and/or transmits an advisory or notification indicating that the slip condition 702 is true.

Here, the process 700 adopts the existing signals transmitted via a Controller Area Network (CAN) bus onboard the vehicle, which reflect whether or not a slip is detected. Then, the process 700 explores the early slip detection by using other vehicle dynamics signals. In this exemplary embodiment, the process 700 calculates the slip angle and self-aligning torque from four CAN bus signals. Initially, the self-aligning torque increases as slip angle. If the road is slippery, the self-aligning torque will decrease while the slip angle increases. Thus, the process 700 detects the early slip condition when self-aligning torque is decreasing while increasing the slip angle.

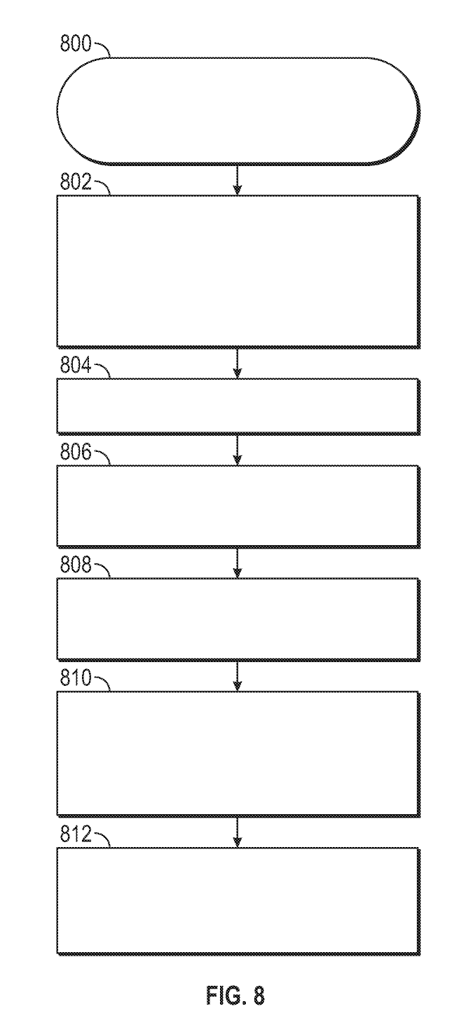

FIG. 8 is a flow chart that illustrates an embodiment of a process 800 for analyzing a driving route at a centralized computer system in communication with a plurality of vehicles traveling the driving route. First, the process 800 requests, via a communication device of the centralized computer system, driving condition data from a plurality of vehicles in operation on the driving route, based on a location of each of the plurality of vehicles (step 802). Next, the process 800 receives the driving condition data, via the communication device (step 804). The process 800 then filters, by the centralized computer system, the driving condition data to obtain relevant driving condition data (step 806). Next, the process 800 stores the relevant driving condition data in a system memory element at the centralized computer system (step 808). The process 800 then generates, by the centralized computer system, notifications associated with severe weather, road anomalies, and slippery roads, based on the relevant driving condition data (step 810). Next, the process 800 transmits, via the communication device, the notifications to a second plurality of vehicles approaching the driving route (step 812).

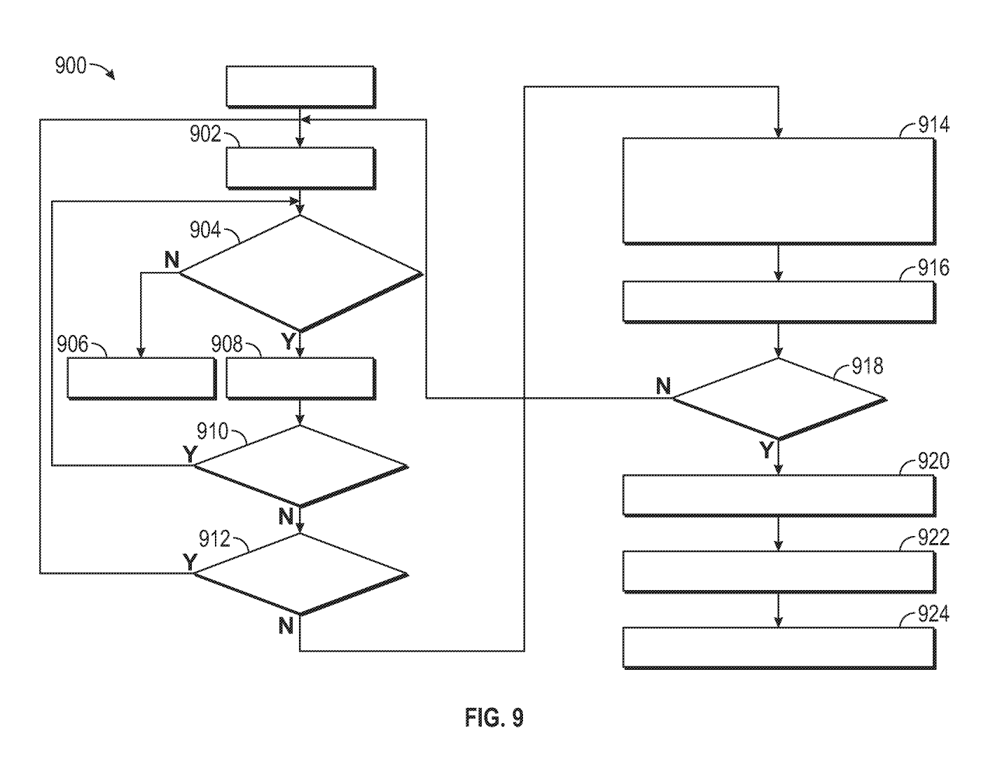

FIG. 9 is a flow chart that illustrates an embodiment of a process 900 for selective sensing of driving condition data acquired and calculated by a plurality of vehicles operating on a driving route. Here, the process 900 uses a historical average for the road condition data that is calculated using the following equation: fₕᵢₛₜ(x,t)=avg(S(x,t)−Sₒᵤₜₗᵢₑᵣ(x,t)). The process 900 also calculates a current estimate of the road condition data using the following equation: \hat{f}(x,t)=αf(x,t)+β\hat{f}(x,t−1).

First, the process 900 initializes by setting t=0 and resetting a counter (m=0) (step 902). The process 900 then determines whether a significant (non-negligible) difference exists between the historical data and the current estimate data (decision 904). Here, the process 900 calculates for node i, \hat{f}(i,t)−fₕᵢₛₜ(i)>ε. When \hat{f}(i,t)−fₕᵢₛₜ(i) is not greater than ε (the “No” branch of 904), then the process 900 determines that the difference between the historical data and the current estimate data is negligible. When the difference between the historical data and the current estimate data is negligible, the process 900 then discards that particular set of road condition data (step 906). Here, the process 900 “filters” the obtained set of driving condition data (i.e., road condition data) by retaining only the relevant driving condition data.

However, when \hat{f}(i,t)−fₕᵢₛₜ(i) is greater than ε (the “Yes” branch of 904), then the process 900 determines that the difference between the historical data and the current estimate data is not negligible, increments the counter m (step 908), and determines whether t<T (decision 910). When t<T (the “Yes” branch of 910), then the process 900 returns to the beginning of the process 900 after the initialization step (step 902), such that the parameter t and the counter m are not reset to zero, and the historical data is again compared to the current estimate data (decision 904). However, when t is not greater than T (the “No” branch of 910), then the process 900 determines whether m<M (decision 912). When m<M (the “Yes” branch of 912), then the process 900 returns to the beginning of the process 900 before the initialization step (step 902). However, when m is not greater than M (the “No” branch of 912), then the process 900 randomly selects n number of vehicles for confirmation (step 914), and receives data from the an number of vehicles confirming the data (step 916).

The process 900 then determines whether m+αn>K (decision 918). When m+αn is not greater than K (the “No” branch of 918), then the process 900 returns to the beginning of the process 900 prior to the initialization step (step 902). However, when m+αn>K (the “Yes” branch of 918), then the process 900 notifies the vehicles traveling in the segments of the road in question (step 920), suppresses redundant reporting (step 922), and the process 900 ends (step 924).

First, the process 900 determines whether a significant (non-negligible) difference exists between the historical data and the current estimate data. The process 900 confirms the driving condition data that has been obtained, and transmits notifications associated with driving condition data that has been obtained. Here, the process 900 confirms the data by performing comparisons with driving condition data obtained from several vehicles. The process 900 detects new trending signals, while preventing impact by occasional random noise; minimizes the latency and cellular cost through local-cloud coordination; and uses algorithms broad enough to handle a rich variety of CAN signals and corresponding traffic events.

The various tasks performed in connection with processes 400-900 may be performed by software, hardware, firmware, or any combination thereof. For illustrative purposes, the preceding description of processes 400-900 may refer to elements mentioned above in connection with FIGS. 1-3. In practice, portions of processes 400-900 may be performed by different elements of the described system. It should be appreciated that processes 400-900 may include any number of additional or alternative tasks, the tasks shown in FIGS. 4-9 need not be performed in the illustrated order, and processes 400-900 may be incorporated into a more comprehensive procedure or process having additional functionality not described in detail herein. Moreover, one or more of the tasks shown in FIGS. 4-9 could be omitted from embodiments of the processes 400-900 as long as the intended overall functionality remains intact.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for acquiring road data onboard a vehicle, the road data associated with a segment of road, the method comprising:
obtaining, via vehicle onboard sensors, sensor data associated with current weather conditions, current road conditions, and a physical road state;
determining whether the current weather conditions indicate existence of severe weather, whether the current road conditions indicate potential slip, and whether the physical road state indicates one or more road anomalies;
generating a road data result, based on existence of severe weather, potential slip, and one or more road anomalies; and
transmitting the road data result, via a vehicle onboard telematics unit.

2. The method of claim 1, further comprising identifying a triangulated location of the vehicle;
wherein the triangulated location is transmitted with the road data result, via the vehicle onboard telematics unit.

3. The method of claim 2, further comprising detecting a time value at which the sensor data is obtained;
wherein the triangulated location is identified at the time value; and
wherein the triangulated location and the road data result are transmitted simultaneously.

4. The method of claim 1, wherein determining whether current weather conditions indicate existence of severe weather further comprises:
detecting activation of one of the vehicle onboard sensors associated with severe weather;
detecting an outside air temperature, via an outside air temperature sensor, wherein the vehicle onboard sensors comprise the outside air temperature sensor; and
when the outside air temperature is greater than a predetermined threshold, identifying a rain condition, wherein the rain condition indicates existence of severe weather.

5. The method of claim 4, further comprising:
when the outside air temperature is not greater than the predetermined threshold, identifying a snow condition, wherein the snow condition indicates existence of severe weather.

6. The method of claim 4, wherein the one of the vehicle onboard sensors comprises at least one of a windshield wiper sensor and a rain sensor.

7. The method of claim 1, further comprising:
determining, via a windshield wiper sensor, an activation level of windshield wipers onboard the vehicle, wherein the vehicle onboard sensors comprise at least the windshield wiper sensor; and
identifying a current precipitation level, based on the activation level;
wherein the road data comprises at least the current precipitation level.

8. The method of claim 1, further comprising:
detecting, via a fog light indicator sensor, activation of fog lights onboard the vehicle, wherein the vehicle onboard sensors comprise at least the fog light indicator sensor;
identifying a fog condition, based on activation of the fog lights;
wherein the road data comprises the fog condition.

9. A system for acquiring road data onboard a vehicle, the system comprising:
a system memory element;
a plurality of vehicle onboard sensors, configured to obtain sensor data associated with current weather conditions, current road conditions, and a physical road state;
a vehicle onboard telematics device, configured to transmit data to a remote server;
at least one processor, communicatively coupled to the system memory element, the plurality of vehicle onboard sensors, and the vehicle onboard telematics unit, the at least one processor configured to:
identify the current weather conditions, the current road conditions, and the physical road state, based on the sensor data;
determine whether the current weather conditions indicate existence of severe weather, whether the current road conditions indicate potential slip, and whether the physical road state indicates one or more road anomalies;
generate a road data result, based on existence of severe weather, potential slip, and one or more road anomalies; and
initiate transmission of the road data result, via the vehicle onboard telematics device.

10. The system of claim 9, wherein the at least one processor is further configured to identify a road elevation based on the physical road state, wherein the one or more road anomalies comprises the road elevation; and
wherein the road elevation comprises at least one of a road bump and a road ramp.

11. The system of claim 10, wherein the plurality of vehicle onboard sensors is further configured to detect a vibration of the vehicle, wherein the vibration is generated when the vehicle contacts the road elevation; and
wherein the at least one processor is further configured to identify the road elevation, based on the vibration.

12. The system of claim 9, wherein the at least one processor is further configured to identify a pothole based on the physical road state; and
wherein the one or more road anomalies comprises the pothole.

13. The system of claim 12, wherein the plurality of vehicle onboard sensors is further configured to detect asymmetric lateral accelerations of the vehicle, wherein the asymmetric lateral accelerations indicate asymmetric vehicle contact with the pothole; and
wherein the at least one processor is further configured to identify the pothole, based on the asymmetric lateral accelerations.

14. The system of claim 9, wherein the at least one processor is further configured to:
identify a slip condition based on the current road conditions; and
generate the road data result to include the slip condition.

15. The system of claim 9, wherein the vehicle onboard telematics device is further configured to:
communicate with an electronic device onboard the vehicle; and
obtain vertical acceleration data from the electronic device;
wherein the at least one processor is further configured to:
evaluate the vertical acceleration data; and
detect vehicle contact with the one or more road anomalies, based on the vertical acceleration data, wherein the one or more road anomalies comprises at least one of a pothole, a road bump, and a road ramp.

16. A method for analyzing a driving route at a centralized computer system, the method comprising:
requesting, via a communication device of the centralized computer system, driving condition data from a plurality of vehicles in operation on the driving route, based on a location of each of the plurality of vehicles;
receiving the driving condition data, via the communication device;
filtering, by the centralized computer system, the driving condition data to obtain relevant driving condition data;
storing the relevant driving condition data in a system memory element at the centralized computer system;
generating, by the centralized computer system, notifications associated with severe weather, road anomalies, and slippery roads, based on the relevant driving condition data;
transmitting, via the communication device, the notifications to a second plurality of vehicles approaching the driving route.

17. The method of claim 16, further comprising:
identifying relevant driving condition data associated with a segment of the driving route, wherein the driving condition data comprises the relevant driving condition data;
generating at least one alert, based on the relevant driving condition data, wherein the notifications comprise the at least one alert;
detecting a subset of the plurality of vehicles in operation on the segment of the driving route;
transmitting the at least one alert to the subset.

18. The method of claim 16, wherein filtering the driving condition data to obtain relevant driving condition data further comprises:
calculating a historical average of the driving condition data associated with a segment of the driving route;
calculating a current estimation of the driving condition data; and
determining the relevant driving condition data, based on the historical average and the current estimation.

19. The method of claim 18, further comprising:
identifying a subset of the driving condition data associated with a particular vehicle, wherein the current estimation is associated with the particular vehicle;
determining whether a difference between the current estimation and the historical average is greater than a predetermined threshold; and
when the difference is greater than a predetermined threshold, determining that the relevant driving condition data comprises the subset.

20. The method of claim 19, further comprising:
when the difference is not greater than a predetermined threshold, determining that the relevant driving condition data does not comprise the subset.
